(19) United States
(12) Patent Application Publication
(10) Pub. No.: US 2021/0319701 A1
(43) Pub. Date: Oct. 14, 2021

(54) INFORMATION PROVIDING DEVICE FOR VEHICLE, AND VEHICLE

(71) Applicant: ISUZU MOTORS LIMITED, Tokyo (JP)

(72) Inventor: Yasuyuki MISHIMA, Fujisawa-shi, Kanagawa (JP)

(73) Assignee: Isuzu Motors Limited, Tokyo (JP)

(21) Appl. No.: 17/271,683

(22) PCT Filed: Aug. 30, 2019
(86) PCT No.: PCT/JP2019/034288

§ 371 Date: Feb. 26, 2021

(30) Foreign Application Priority Data
Aug. 31, 2018 (JP) 2018-163369

(51) Int. Cl. G08G 1/00; G08G 1/0967; B60W 30/18; B60W 50/14

(52) U.S. Cl. CPC G08G 1/22; B60W 50/14; B60W 30/18163; G08G 1/096725

(57) ABSTRACT

This information providing device for a vehicle can improve fuel efficiency. The information providing device for a vehicle is provided with: a determination unit which determines whether or not an outside vehicle, which does not belong to a convoy, has cut into an inter-vehicle region, which is the region between vehicles traveling in convoy continuously in the longitudinal direction; an information generation unit which, if the determination unit has determined that an outside vehicle has cut in, generates cut-in handling information for handling the outside vehicle that has cut in; and an information providing control execution unit which performs control for providing the outside vehicle with the cut-in handling information generated by the information generation unit.

### TECHNICAL FIELD

The present disclosure relates to a vehicle information provision apparatus and a vehicle.

### BACKGROUND ART

In the related art, PTL 1 discloses a vehicle travel control apparatus mounted in each of a plurality of vehicles and configured to perform travelling control through mutual communication of sending and receiving information. In the disclosure, one vehicle travel control apparatus is set as a host device, and the positions of platooning vehicles are recognized, and, a travel command signal is transmitted to other vehicles so as to achieve a predetermined vehicle-to-vehicle distance. In this manner, vehicles can travel with a reduced vehicle-to-vehicle distance, and thus fuel efficiency can be improved.

### CITATION LIST

### Patent Literature

### PTL 1

Japanese Patent Application Laid-Open No. 2008-74210

### SUMMARY OF INVENTION

### Technical Problem

Incidentally, when vehicles are travelling, a vehicle that is not targeted for a platoon may cut into the platoon. In this case, the platoon is divided, and the vehicles cannot travel with a reduced vehicle-to-vehicle distance, and the fuel efficiency cannot be improved.

An object of the present disclosure is to provide a vehicle information provision apparatus and a vehicle that can improve the fuel efficiency.

### Solution to Problem

To achieve the above-mentioned object, a vehicle information provision apparatus of an embodiment of the present disclosure includes a determination section configured to determine whether there is cut-in of an external vehicle in an inter-vehicle region that is a region sandwiched between travelling vehicles organized in a platoon, the travelling vehicles being consecutive in a front-rear direction, the external vehicle being a vehicle that is not targeted for the platoon; an information generation section configured to generate cut-in handling information for handling the external vehicle when the determination section determines that there is cut-in of the external vehicle; and an information provision control execution section configured to execute a control of providing the external vehicle with the cut-in handling information generated by the information generation section.

In addition, a vehicle of an embodiment of the present disclosure includes the above-mentioned vehicle information provision apparatus.

### Advantageous Effects of Invention

The present disclosure can improve the fuel efficiency.

### BRIEF DESCRIPTION OF DRAWINGS

FIG. 1 is a control block diagram schematically illustrating a configuration of a vehicle information provision apparatus according to an embodiment of the present disclosure;

FIG. 2 schematically illustrates a vehicle travelling in an own lane or an adjacent lane; and

FIG. 3 is a flowchart of an exemplary cut-in determination process operation according to the embodiment of the present disclosure.

### DESCRIPTION OF EMBODIMENTS

An embodiment of the present disclosure is described below with reference to the drawings.

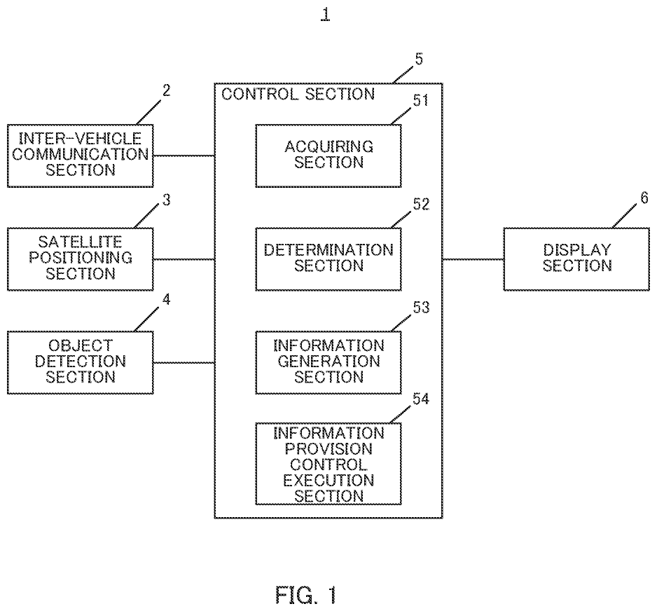

FIG. 1 is a control block diagram schematically illustrating a configuration of vehicle information provision apparatus 1 according to the embodiment of the present disclosure. Vehicle information provision apparatus 1 includes inter-vehicle communication section 2, satellite positioning section 3, object detection section 4, control section 5, and display section 6 (an example of “notification section”). Vehicle information provision apparatus 1 is provided in each vehicle.

Inter-vehicle communication section 2 is a communication apparatus configured to use a wireless radio wave of a predetermined frequency band and transmit and receive it between vehicles, and exchanges a variety of information related to the vehicle between the vehicles. Here, the variety of information on vehicles includes vehicle location information. Note that the vehicle location information is information determined by satellite positioning section 3.

Satellite positioning section 3 three-dimensionally measures the position of a vehicle. A publicly known wireless global positioning system (GPS) is used for satellite positioning section 3, for example.

Object detection section 4 detects an object in an inter-vehicle region that is a region sandwiched between vehicles organized in a platoon consecutively travelling in the front-rear direction. Object detection section 4 is a millimeter-wave sensor, for example. The millimeter-wave sensor emits, from the vehicle side toward the inter-vehicle region, electromagnetic waves as transmission waves, and receives the reflection waves of the emitted transmission waves.

Control section 5 is composed of a microcomputer including a central processing unit (CPU), a read only memory (ROM), a random access memory (RAM), an input interface, and an output interface. The CPU reads a program corresponding to the processing from the ROM and loads it into the RAM, and, performs a centralized control of operations of each block and the like in cooperation with the loaded program. Note that in the present embodiment, control section 5 functions as acquiring section 51, determination section 52, information generation section 53, and information provision control execution section 54. Note that these functions may be included in an electric control unit (ECU), which is an apparatus that uses an electronic circuit to control each system in a vehicle. In addition, some or all of these functions may be provided separately from the ECU.

Acquiring section 51 acquires a detection result of object detection section 4. Control section 5 calculates object location information on the basis of the detection result of object detection section 4. In addition, acquiring section 51 acquires a measurement result (vehicle location information) of satellite positioning section 3.

Determination section 52 determines whether there is a cut-in external vehicle in the inter-vehicle region. More specifically, determination section 52 compares the object location information calculated based on the detection result of object detection section 4 and the acquired measurement result (vehicle location information) of satellite positioning section 3, and, when the location information of them match each other, determination section 52 determines that there is a cut-in external vehicle in the inter-vehicle region.

Information generation section 53 generates cut-in handling information for handling a cut-in external vehicle. The cut-in handling information is information that indicates occurrence of cut-in of an external vehicle, for example. Here, the generation of cut-in handling information includes generation of cut-in handling information using data stored in advance in a storage section (for example, the ROM).

Information provision control execution section 54 executes a control of providing the external vehicle with the cut-in handling information generated by information generation section 53. For example, information provision control execution section 54 performs a control of causing display section 6 to display the cut-in information.

Display section 6 displays the cut-in handling information. Display section 6 is disposed at a position where it can be visually recognized from the external vehicle side. For display section 6, a liquid crystal display (LCD) is used, for example. When it is determined that there is a cut-in external vehicle in the inter-vehicle region, control section 5 sends the cut-in handling information to display section 6. The sent cut-in display information is displayed by display section 6.

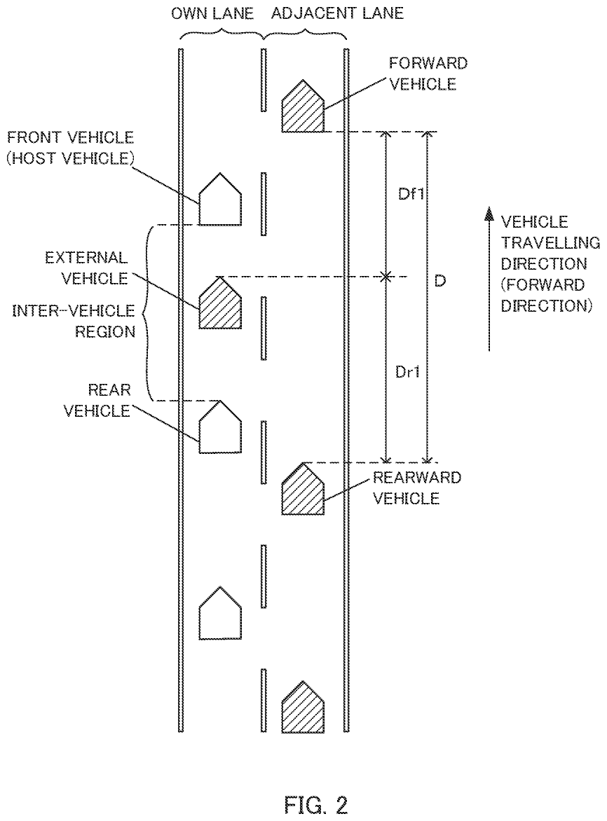

Next, a specific example of vehicle information provision apparatus 1 is described with reference to FIG. 2. FIG. 2 schematically illustrates a vehicle travelling in the own lane or an adjacent lane. In FIG. 2, white pentagons indicate travelling vehicles organized in a platoon, and hatched pentagons indicate vehicles that is not targeted for the platoon.

In the following description, the vehicle travelling direction may be referred to as “forward direction”. In addition, a region sandwiched between a front vehicle and a rear vehicle organized in a platoon travelling in a line in the front-rear direction is referred to as “inter-vehicle region”. In addition, a front vehicle may be referred to as “host vehicle”. In addition, a vehicle cut into the inter-vehicle region is referred to as “external vehicle”.

Note that vehicle information provision apparatus 1 is assumed to be provided in the host vehicle. In addition, display section 6 is disposed in the back surface (for example, the rear door or the rear frame of a van-type truck) of the host vehicle. In addition, the cut-in handling information is visual information such as “cutting-in”, for example.

Object detection section 4 detects an object in the inter-vehicle region between the host vehicle (front vehicle) and a rear vehicle. Acquiring section 51 acquires a detection result of object detection section 4. Control section 5 calculates object location information on the basis of the detection result of object detection section 4.

Acquiring section 51 acquires the positioning result (vehicle location information) of satellite positioning section 3. Determination section 52 compares the object location information calculated based on the detection result of object detection section 4 and the positioning result (vehicle location information) of satellite positioning section 3 to determine whether there is a cut-in external vehicle that is not targeted for the platoon in the inter-vehicle region.

When it is determined that there is a cut-in external vehicle in the inter-vehicle region, control section 5 sends the cut-in handling information to display section 6. Display section 6 receives and displays the cut-in handling information. Since display section 6 is disposed in the back surface of the host vehicle, the cut-in handling information displayed on display section 6 can be visually recognized from the external vehicle side.

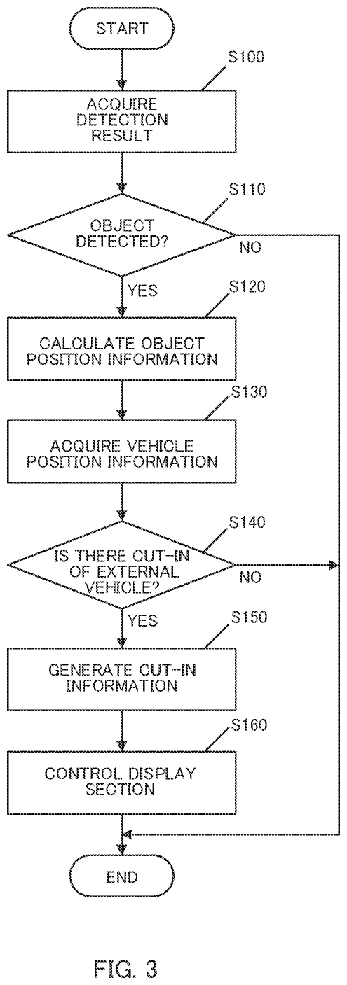

Next, a cut-in determination process operation according to the embodiment of the present disclosure is described with reference to FIG. 3. FIG. 3 is a flowchart of an exemplary cut-in determination process operation according to the embodiment of the present disclosure. The processing of the flowchart is appropriately started during a platoon travelling of vehicles organized in a platoon.

First, at step S100 illustrated in FIG. 3, acquiring section 51 acquires a detection result of object detection section 4.

Next, at step S110, determination section 52 determines whether an object has been detected on the basis of the detection result of object detection section 4. When an object has been detected (step S110: YES), the process is advanced to step S120. When no object has been detected (step S110: NO), the process is terminated.

At step S120, control section 5 calculates object location information on the basis of the detection result of object detection section 4.

Next, at step S130, acquiring section 51 acquires the measurement information (vehicle location information) of satellite positioning section 3.

Next, at step S140, determination section 52 compares the object location information and the vehicle location information to determine whether there is a cut-in external vehicle in the inter-vehicle region. When there is a cut-in external vehicle (step S140: YES), the process is advanced to step S150. When there is no cut-in external vehicle (step S140: NO), the process is terminated.

At step S150, information generation section 53 generates cut-in handling information that indicates occurrence of cut-in of an external vehicle in the inter-vehicle region.

Next, at step S160, information provision control execution section 54 executes a control of causing display section 6 to display the cut-in handling information.

Vehicle information provision apparatus 1 of the present embodiment includes determination section 52 configured to determine whether there is a cut-in external vehicle that is not targeted for the platoon in the inter-vehicle region that is a region sandwiched between vehicles organized in a platoon consecutively travelling in the front-rear direction, information generation section 53 configured to generate cut-in handling information for handling the cut-in external vehicle when determination section 52 determines that there is a cut-in external vehicle, and display section 6 configured to display the cut-in handling information. The display of the cut-in handling information provides a notification to leave the inter-vehicle region to the external vehicle. When the external vehicle has left the inter-vehicle region, the vehicles can travel with a reduced vehicle-to-vehicle distance, and thus the fuel efficiency can be improved.

Next, a modification of the present embodiment is described.

When there is a cut-in external vehicle in the inter-vehicle region that is a region sandwiched by van-type trucks in a line in the front-rear direction in the travelling direction, the cut-in handling information is transmitted to the external vehicle. However, for example, when an external vehicle changes the lane from the own lane to an adjacent lane, van-type trucks on the front and rear sides of the external vehicle considerably block the front and rear visibility of the external vehicle, and consequently it is difficult for the external vehicle to change the lane.

In view of this, in the modification, information generation section 53 generates auxiliary information for assisting the lane change of the external vehicle. More specifically, information generation section 53 generates lane change information that indicates a region for lane change of the external vehicle. In the present embodiment, acquiring section 51 acquires a measurement result of satellite positioning section 3 (here, location information of a vehicle in the adjacent lane). On the basis of location information of a vehicle in the adjacent lane, control section 5 calculates distance Df1 between an external vehicle and a forward vehicle (the external vehicle and the first vehicle from the front in the adjacent lane illustrated in FIG. 2) in the vehicle travelling direction. In addition, on the basis of location information of a vehicle in the adjacent lane, control section 5 calculates distance Dr1 between an external vehicle and a rearward vehicle (the external vehicle and the rearmost vehicle in the adjacent lane illustrated in FIG. 2) in the vehicle travelling direction.

Control section 5 determines distance D between the forward vehicle and the rearward vehicle as lane change information by adding up distance Df1 and distance Df2. Control section 5 sends the lane change information to display section 6. Display section 6 displays the sent lane change information.

Vehicle information provision apparatus 1 according to the modification can assist the lane change of the external vehicle by providing lane change information to the external vehicle side, and thus the ease of the lane change of the external vehicle increases.

Note that in the modification, the auxiliary information is the lane change information that indicates a region where the external vehicle can move when the external vehicle changes the lane, but the auxiliary information may be information of the road on the front side and the rear side of a platoon. Information of the road on the front side and the rear side of a platoon is generated by information generation section 53 on the basis of location information of vehicles organized in the platoon and location information of vehicles in a region around the platoon.

In addition, the auxiliary information may be information representing the timing for lane change of the external vehicle. For example, the ease of lane change of the external vehicle is increased by providing information indicating appropriate timing for lane change or inappropriate timing for lane change to the external vehicle side.

In addition, the auxiliary information may be a trigger for automatic lane change. For example, when the timing is appropriate for lane change, a vehicle can be safely separated from a platoon by generating a trigger for a vehicle equipped with an automatic operation function including lane change function.

Note that while satellite positioning section 3 is used as a positioning apparatus for measuring the vehicle position in the present embodiment, the positioning apparatus is not limited to satellite positioning section 3, and may be a vehicle speed sensor, a yaw rate sensor, a device that performs positioning by so-called dead reckoning based on data of a steering angle sensor, or a device that uses a beacon and the like.

In addition, while a millimeter-wave sensor is used as object detection section 4 in the present embodiment, it is also possible to use a laser sensor, an ultrasound sensor, or a camera that captures an image of an object.

In addition, while display section 6 is disposed in the back surface of the host vehicle in the present embodiment, display section 6 may be disposed in an external vehicle. Display section 6 disposed in an external vehicle may be an operation display section such as a touch panel display, for example. In this case, information provision control execution section 54 performs a control of causing inter-vehicle communication section 2 to perform an inter-vehicle communication with the external vehicle. The lane change information is provided from the host vehicle to the external vehicle side through inter-vehicle communication section 2, for example. In addition, display section 6 disposed in an external vehicle may be a mobile terminal that can be mounted in an external vehicle such as a tablet terminal (pad terminal), a personal computer, and a smartphone, for example

In addition, while display section 6 that notifies cut-in handling information to the external vehicle side as visual information is used as the notification section in the present embodiment, it is also possible use a sound generator such as a buzzer and a speaker that notifies cut-in handling information to the external vehicle side as sound information, for example. Note that both display section 6 and the sound generator may be used.

The above-mentioned embodiments are merely examples of the present disclosure, and the technical scope of the present disclosure should not be construed as limited by them. In other words, various modifications of the present disclosure may be made insofar as they are within the spirit and scope of the present disclosure.

This application is entitled to and claims the benefit of Japanese Patent Application No. 2018-163369 filed on Aug. 31, 2018, the disclosure each of which including the specification, drawings and abstract is incorporated herein by reference in its entirety.

### INDUSTRIAL APPLICABILITY

The vehicle information provision apparatus of the present disclosure is favorably utilized for vehicles that are required to improve fuel efficiency.

### REFERENCE SIGNS LIST

1 Vehicle information provision apparatus
2 Inter-vehicle communication section
3 Satellite positioning section
4 Object detection section
5 Control section
6 Display section
51 Acquiring section
52 Determination section
53 Information generation section
54 Information provision control execution section

1. A vehicle information provision apparatus comprising:
a determination section configured to determine whether there is cut-in of an external vehicle in an inter-vehicle region that is a region sandwiched between travelling vehicles organized in a platoon, the travelling vehicles being consecutive in a front-rear direction, the external vehicle being a vehicle that is not targeted for the platoon;
an information generation section configured to generate cut-in handling information for handling the external vehicle when the determination section determines that there is cut-in of the external vehicle; and
an information provision control execution section configured to execute a control of providing the external vehicle with the cut-in handling information generated by the information generation section.

2. The vehicle information provision apparatus according to claim 1, further comprising a notification section configured to make a notification of the cut-in handling information that is generated.

3. The vehicle information provision apparatus according to claim 1, wherein the cut-in handling information includes auxiliary information for assisting lane change of the external vehicle.

4. The vehicle information provision apparatus according to claim 3, wherein the auxiliary information includes lane change information that indicates a region where the external vehicle is movable when the external vehicle changes a lane.

5. The vehicle information provision apparatus according to claim 4, further comprising an acquiring section configured to acquire, through a communication with outside, location information of the vehicles organized in the platoon and location information of a vehicle in a region around the platoon, wherein
the information generation section generates the lane change information on a basis of the location information of the vehicle acquired by the acquiring section.

6. A vehicle comprising the vehicle information provision apparatus according to claim 1.
